(19) United States
(12) Patent Application Publication
(10) Pub. No.: US 2026/0278501 A1
(43) Pub. Date: Sep. 17, 2026

(54) SYSTEM FOR SUPPLY CHAIN DESIGN AND PLANNING WITH BOUNDED REASONING

(71) Applicant: Coupa Software Incorporated, San Mateo, CA (US)

(72) Inventor: Alan McCord, Forney, TX (US)

(21) Appl. No.: 19/210,002

(22) Filed: May 16, 2025

Related U.S. Application Data
(60) Provisional application No. 63/770,781, filed on Mar. 12, 2025.

(51) Int. Cl. G06Q 10/0631; G06F 16/242; G06F 17/11

(52) U.S. Cl. CPC G06Q 10/06315; G06F 16/243; G06F 17/11

(57) ABSTRACT

In an embodiment, a computer-implemented method includes receiving in a visual user interface a natural-language query specifying a supply chain problem, identifying analytical tasks contained in or implied by the natural-language query, generating a meta optimization model representing the analytical tasks, programmatically calling a constrained optimization solver to solve the meta optimization model and receiving from the constrained optimization solver a response specifying a sequence of analysis operations and an assignment of each analysis operation to one or more agents, for each analysis operation, invoking at least one agent as specified in the assignment to execute the analysis operation and receiving a response specifying an execution result for each analysis operation, generating a distilled result based on the execution result for each analysis operation, generating a natural-language response based on the distilled result, and presenting in the visual user interface the natural-language response as a response to the natural-language query.

### BENEFIT CLAIM

This application claims the benefit of provisional application 63/770,781, filed Mar. 12, 2025, the entire contents of which are hereby incorporated herein by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. ©2025 Coupa Software Incorporated.

### TECHNICAL FIELD

The present disclosure relates generally to computer-implemented techniques for supply chain design and planning based on applied artificial intelligence and machine learning.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

A supply chain comprises a set of physical facilities and means of transportation that are used to receive and transform raw materials or commodities into finished goods and place those goods in the possession of a consumer. With modern international long-distance multi-hop supply chains, each having multiple different possible transportation routes and means of transportation, each involving numerous different raw materials, components, storage, assembly, and shipping facilities, all multiplied by dozens to thousands of products, determining the best lanes, paths or routes to an ultimate destination becomes exceedingly complex and beyond the scope of human mental or manual processing.

Computer-implemented methods of analyzing supply chains, based upon graph analysis and network analysis algorithms, have entered wide use, and have become critical to driving decisions concerning the movement of commodities, partly finished goods, and completed products. Supply chain analysis computer program applications integrate complex mathematics and large databases into the practical application of visually displaying path and route recommendations and/or generating instructions to nodes of the supply chain to change transportation actions. Contemporary supply chain analysis commonly focuses on sites or nodes, such as manufacturers, distribution centers, customers, and lanes and paths between them. A lane can be a single route between a first node and a second node. In contrast, a path comprises a plurality of lanes. It typically represents an end-to-end movement of commodities or goods from the point of manufacture to the point of consumption.

Supply chain design and planning (SCDP) primarily involves solving network optimization problems using software-implemented algorithms that seek to optimize paths in a network of nodes and lanes. One objective of network optimization is to minimize the cost of the movement of commodities or goods through the network, as well as costs at nodes, and to maximize the profit or return to an entity that owns, operates, manages, or controls the network. The construction of a computer model of the supply chain and its subsequent optimization over decision variables is a complex, time-consuming, and expensive task, both in terms of the human effort to gather data and construct the model, but also the computational cost of finding feasible and optimal solutions to the model. In the case of supply chain design, the design of a network may be reconsidered only from time to time, however in supply chain planning and operations, the optimizations can be essentially continuous over time as supply chain stakeholders need to adjust the supply chain in response to or in anticipation of changes of internal and external factors. Users of such systems are often under intense time pressure to evaluate many “what-if” scenarios and present decision options to upper management or to enter into automated execution systems. In some situations, it may be important to the business to be able to compute only an approximate answer quickly or, if there is sufficient time and compute budget, run optimization processes for longer to get more accurate results. The monetary value in supply chain is substantial such that even a 1% improvement in a solution can correspond to millions of dollars in benefit to the supply chain stakeholders.

### SUMMARY

The appended claims may serve as a summary of the disclosure.

### BRIEF DESCRIPTION OF THE DRAWINGS

In the drawings:

FIG. 1A illustrates a distributed computer system showing the context of use and principal functional elements with which one embodiment could be implemented.

FIG. 1B illustrates an example graph of agents.

FIG. 2 illustrates a functional workflow for supply chain design and planning with bounded reasoning in accordance with the disclosed embodiments.

FIG. 3A illustrates a flow diagram of a method for supply chain design and planning with bounded reasoning in accordance with the disclosed embodiments.

FIG. 3B illustrates another flow diagram of a method for supply chain design and planning with bounded reasoning.

FIG. 4 is a block diagram of an example computer system that may be used in implementing supply chain design and planning with bounded reasoning.

### DETAILED DESCRIPTION

In the following description, numerous specific details are outlined to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as communicating with each other need not be in continuous communication unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in an embodiment or occurrence, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1.0 General Overview

Supply chain design and planning often involves multiple interdependent decisions and scenarios, each with numerous variables and constraints. Traditional operations research techniques like linear programming and constraint programming can optimally solve well-defined subproblems like network flow or facility location problems but require precise formulation and do not natively handle unstructured inputs or produce explanatory summaries. On the other hand, Large Language Models (LLMs) excel at understanding natural language input and generating human-readable outputs or code but have limited reasoning depth for complex logic or combinatorial decision-making. While advanced prompting techniques and test-time computation can extend an LLM's reasoning ability, this extension remains significantly bounded compared to the exhaustive search capabilities of constraint programming (CP) or mixed integer programming (MIP) solvers. Examples of test-time computing include chain-of-thought reasoning by LLMs, external tool use, or step-by-step code execution.

In addition to test-time compute within individual language model agents, various topologies of agents with optional tool calling have been used to scale reasoning abilities by individual agents taking responsibility for certain decision variables, or specific agents representing an objective function of certain stakeholders in a supply chain. However, designing such agentic systems is complex. The sequential chaining of approximate agentic steps leads to an exponential decrease in the accuracy of the agent sequence. Language models are used in a hierarchical way so that one LLM agent can attempt to orchestrate a plurality of other agents under its control, or a group of LLM agents collectively try to self-organize to solve a given optimization problem. However, these systems are unpredictable, unstable, slow to converge, and cannot scale to real-world problems with millions of decision variables. What is needed is a mathematical and statistically based approach to design such systems of agents, in particular systems of agents where generative language model agents are combined with other mathematical algorithmic agents.

In the embodiments disclosed herein, a computer system is developed to address these challenges by solving two coupled optimization problems. There is an upper “meta” design and control layer concerned with optimal decisions governing the supply and demand of computational resources to solve problems in a lower or “base” layer. Specifically, the goal of this meta-level optimization problem is to orchestrate the supply (creation) optimally and demand (execution) of hybrid agents in a system to solve a base-level problem to be within a target accuracy, and within a desired compute time and compute cost and given the overall performance and accuracy constraints specified by a user. The base-level optimization problem is to optimally orchestrate the supply and demand of physical real-world entities in a model of a real-world supply chain, subject to real-world supply chain constraints. At both the meta and base levels, a constrained optimization is performed.

By hybrid agents above, this disclosure means agents that perform pure numerical data processing tasks, agents that perform machine-learning statistical tasks, agents that are pure LLM agents, agents that perform pure mathematical optimization (e.g. a MIP optimizer solver running as an agent), agents that use Constraint Programming (CP), agents that are metaheuristic optimizers (e.g. an evolutionary algorithm), agents that write code in SQL, python or other computer languages which is then executed within the same agent or by downstream agents, agents that are fast-approximate optimization methods that temporarily keep certain decision variables constrained, agents that execute heuristic optimization methods (e.g. greedy algorithms, local search), or any suitable software entity with its internal objectives, or hybrid combinations of the above that can also use tool calling, or Model Control Protocol and so on.

Furthermore, the embodiments disclosed herein develop a method to improve the accuracy (including reduction of hallucination rates) of any chain of agents through an iterative complexity reduction process along an agent chain with a parallel execution consensus mechanism to detect any remaining error by hallucination. In this way, the agent chains can trade off accuracy, compute time, and cost under the control of the meta layer while solving the real-world supply chain problem.

As a real-world supply chain needs to foresee, prepare for, and operate under the effect of changing factors, including external shocks and disruptions, the AI in the upper meta-layer of the current invention automatically evolves and redistributes to continuously redesign and replan the real-world supply chain in an optimal way without manual redesign. Furthermore, the fact that the meta-level problem has constrained optimization goals of accuracy, compute time and compute cost mean that the upper meta-level can operate in an always-on fashion, continuously exploring, finding and exploiting new solutions within computational budgets that are justified by the monetary benefits immediately seen in the better results returned by the real-world supply chain models.

The constrained optimization that is performed in both optimization levels can use any optimization method that allows an optimization problem to be solved subject to constraints which includes Mixed Integer Programming (MIP), Constraint Programming (CP) or to first transform the constrained optimization into an unconstrained one using penalty functions to make more optimization methods available for use.

The hybrid agents can perform flexible integration, computation, and interpretation tasks. Previous artificial intelligence (AI) planning approaches required manually encoding logic before analysis. However, manually formulating such plans or writing code for each scenario is labor-intensive and error prone. The embodiments disclosed herein address these challenges by automatically developing a meta-level compute problem from a high-level natural language query, solving it with a CP orchestrator to obtain a valid action plan, and having agents, including LLM-based agents, carry out each step. This hierarchical approach ensures that each sub-task is executed within the scope of the LLM's capabilities or delegated to appropriate solvers, thereby minimizing hallucination and error while maximizing analytical depth. The high-level computing problem may include compute time, cost, or accuracy constraints.

In one embodiment, a computer system can solve complex supply chain design and planning problems by combining a CP orchestrator with multiple agents specialized in code generation and analysis. The CP orchestrator is programmed to execute high-level planning and compute task allocation, exploring combinations of analysis steps and agent assignments to satisfy the user's request under given constraints. A system of this architecture addresses the reasoning limitations of LLMs by offloading intensive combinatorial search and optimization to formal solver agents while allowing LLM agents to perform flexible tasks such as generating code, processing data, and summarizing results.

The system can operate using two levels of optimization. First, a top-level CP orchestrator optimizes the sequence of tasks and agent usage, forming a meta-plan. Second, some of the LLM-driven tasks may invoke secondary CP or MIP solvers to handle specific supply chain planning sub-problems. For example, if no feasible mix of agents and operations can be found for the meta-plan, the orchestrator can be programmed to indicate that a feasible mix is not possible and/or prompt the relaxation of requirements or other fallback strategies rather than producing an invalid plan. Integrating formal optimization at the meta-level and lower agent level with generative AI provides robust, scalable analysis of multiple supply chain scenarios or design problems, delivering optimal or near-optimal solutions with clear natural language explanations.

In various embodiments, the disclosure encompasses the subject matter of the following numbered clauses:
1. A computer-implemented method executed using a computer system, the method comprising: receiving in a visual user interface a natural-language query specifying a supply chain problem; identifying a plurality of analytical tasks contained in or implied by the natural-language query; generating a meta optimization model representing the plurality of analytical tasks, wherein the optimization model comprises a plurality of agents corresponding to a plurality of analysis operations and a plurality of constraints characterizing dependencies between the plurality of operations; programmatically calling a constrained optimization solver to solve the meta optimization model and receiving from the constrained optimization solver a response specifying a sequence of analysis operations and an assignment of each analysis operation among the sequence of analysis operations to one or more agents of a plurality of agents; for each analysis operation, invoking a particular agent specified in the assignment to execute the analysis operation and receiving a response specifying an execution result for each analysis operation; generating a distilled result based on the execution result for each analysis operation; generating a natural-language response based on the distilled result; and presenting in the visual user interface the natural-language response as a response to the natural-language query. By “distilled” this disclosure means an extracted, purified, concentrated or aggregated representation of the output information that is smaller in size or complexity but is still sufficient for a subsequent reasoning or decision step.
2. The computer-implemented method of clause 1 further comprising determining at least one analysis operation comprises solving a sub-problem of the supply chain problem and programmatically calling a secondary constrained optimization solver during the execution of the at least one analysis operation to compute a solution for the sub-problem.
3. The computer-implemented method of clause 1, wherein each agent of the plurality of agents is configured for a particular type of task, wherein the plurality of agents comprise one or more of a first agent configured for code generation, a second agent configured for data retrieval, a third agent configured for data integration, a fourth agent configured for analytical reasoning, and a fifth agent configured for summarization.
4. The computer-implemented method of clause 1, further comprising, responsive to receiving the natural-language query, programmatically calling a supply chain planner or database and retrieving supply chain data from the supply chain planner or a database, wherein executing at least one of the plurality of analysis operations comprises calling the one or more agents with an input specifying the supply chain data and instructions to execute the at least one analysis operation.
5. The computer-implemented method of clause 1, wherein for at least one analysis operation, invoking the one or more agents to execute the at least one analysis operation comprises: invoking a first agent to generate code in a programming language for the at least one analysis operation, wherein the first agent is configured for code generation; and invoking a second agent of the one or more agents to execute the code for the at least one analysis operation, wherein the second agent is configured for code execution.
6. The computer-implemented method of clause 5, further comprising executing the code by programmatically calling a secondary constrained optimization solver to solve an optimization problem associated with the at least one analysis operation.
7. The computer-implemented method of clause 1, further comprising, for each analysis operation, accessing one or more intermediate results from the one or more agents and evaluating an output complexity of the one or more intermediate results from the one or more agents using one or more complexity metrics.
8. The computer-implemented method of clause 7, further comprising: accessing a first intermediate result of the one or more intermediate results produced by a first agent; and using the one or more complexity metrics, quantifying an information content and a structure of the first intermediate result and determining a risk of hallucination or misinterpretation in each analysis operation.
9. The computer-implemented method of clause 8, further comprising: determining that one or more of the complexity metrics for the first intermediate result exceed a predefined threshold; and invoking the first agent to regenerate the first intermediate result, based on one or more of a simplification or a compression, re-evaluating the regenerated first intermediate result using the one or more of the complexity metrics, and repeating the invoking and the re-evaluating until the one or more of the complexity metrics are below the predefined threshold.
10.The computer-implemented method of clause 7, wherein the one or more complexity metrics comprise one or more of Kolmogorov complexity, transformer perplexity, contextual information density, numerical magnitude spectrum, or token count.
11.The computer-implemented method of clause 1, further comprising, for at least one analysis operation, invoking the two or more agents among the plurality of agents in parallel to execute the at least one analysis operation; comparing execution results produced by the two or more agents to detect an inconsistency among the two or more agents or a hallucinated content produced by one agent of the two or more agents; and executing a consensus algorithm on the execution results to generate a consensual execution result for the at least one analysis operation.
12.The computer-implemented method of clause 11, further comprising determining a confidence score for the consensual execution result based on a degree of agreement between the execution results produced by the plurality of agents.
13.The computer-implemented method of clause 11, further comprising: executing the consensus algorithm on the execution results produced by the plurality of agents to identify one or more aspects of the execution results having consensus from the plurality of agents; and selecting the identified one or more aspects of the execution results or synthesizing from the identified one or more aspects of the execution results to generate the consensual execution result.
14.The computer-implemented method of clause 1, wherein the natural-language query specifies comparing a plurality of supply chain scenarios, and wherein the plurality of analysis operations comprise one or more of: calculating one or more performance metrics for each supply chain scenario of the plurality of supply chain scenarios; comparing the one or more performance metrics between two or more supply chain scenarios of the plurality of supply chain scenarios; analyzing network flows or operational details for each supply chain scenario of the plurality of supply chain scenarios; identifying structural or outcome differences between two or more supply chain scenarios of the plurality of supply chain scenarios; analyzing contributing factors within each supply chain scenario of the plurality of supply chain scenarios; or evaluating a respective impact of each supply chain scenario of the plurality of supply chain scenarios.
15.The computer-implemented method of clause 1, wherein the natural-language query specifies comparing a plurality of supply chain scenarios, and wherein the plurality of analysis operations comprise identifying structural or outcome differences between the plurality of supply chain scenarios, the identifying comprising: for each supply chain scenario of the plurality of supply chain scenarios, generating a scenario model as one or more graphs or structured data, thereby forming a plurality of scenario models; calculating one or more quantitative measures for each scenario model of the plurality of scenario models based on the graphs or structured data; comparing the plurality of scenario models based on their respective quantitative measures to detect structural or outcome differences; identifying one or more changes in the quantitative measures between two or more scenario models of the plurality of scenario models; and producing the structural or outcome differences that characterize a divergence between the plurality of supply chain scenarios based on the identified one or more changes in the quantitative measures between the two or more scenario models.
16.The computer-implemented method of clause 15, further comprising generating a natural-language summary or recommendation based on the structural or outcome differences, the generating comprising invoking a first agent among the plurality of agents to translate the structural or outcome differences into an explanation of one or more implications.

Technical advantages of certain embodiments of this disclosure may include one or more of the following. Certain systems and methods described herein may conduct structured, correct-by-design reasoning and optimized multi-step planning for supply chain analysis. Certain systems and methods described herein may improve flexibility and integration with existing supply chain tools and databases. Certain systems and methods described herein may perform hierarchical problem-solving. Certain systems and methods described herein may provide a natural-language interface with expert-level precision. Certain embodiments of the present disclosure may include some, all, or none of these advantages. These advantages and other features will be more clearly understood from the following detailed description taken in conjunction with the accompanying drawings and claims.

### 2. Structural & Functional Overview

### 2.1 Distributed Computer System Example

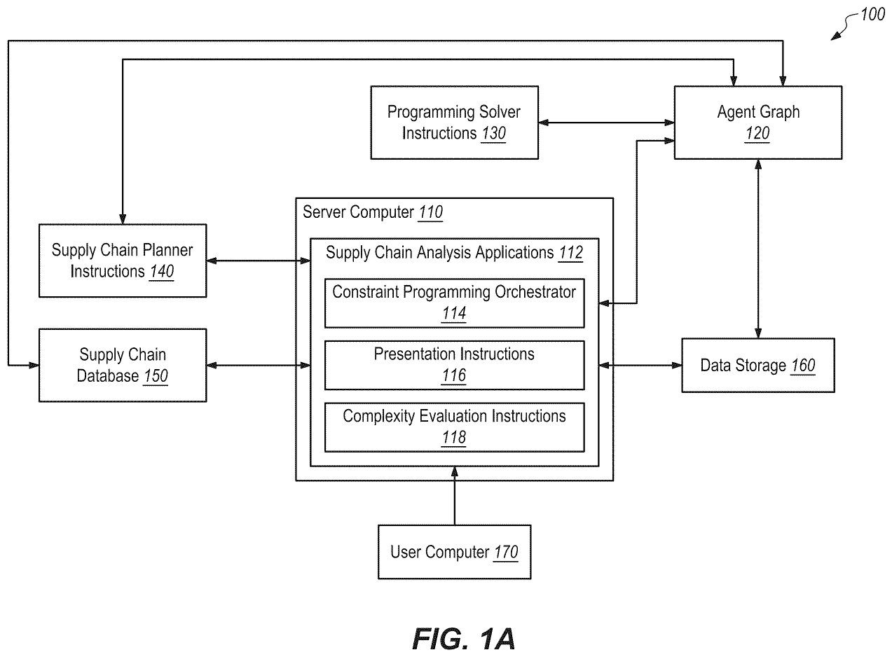

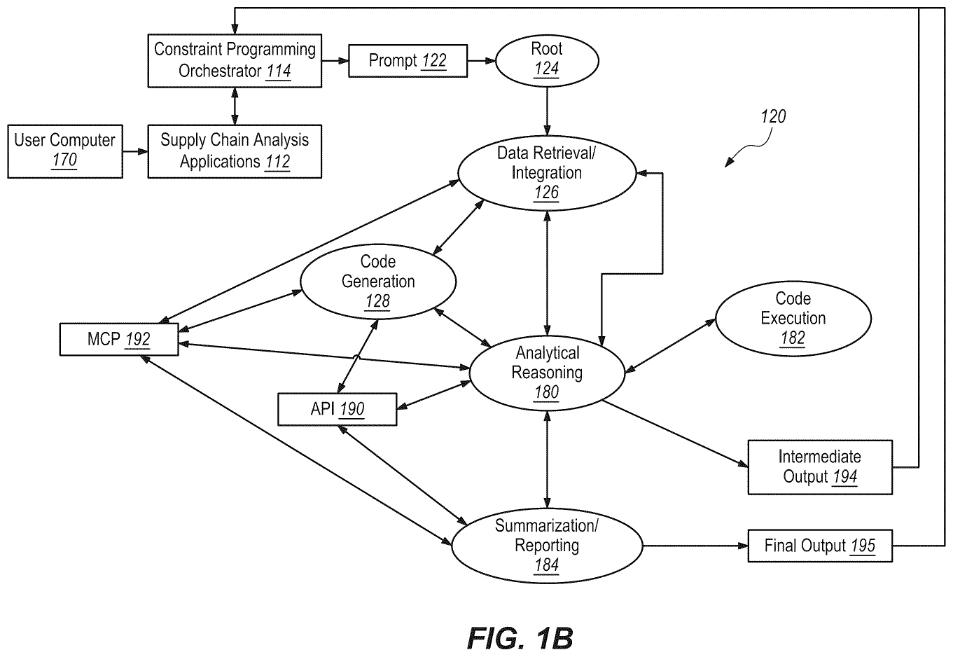

FIG. 1A illustrates a distributed computer system to show the context of use and principal functional elements with which one embodiment could be implemented. In an embodiment, a computer system 100 comprises components that are implemented at least partially by hardware at one or more computing devices, such as one or more hardware processors executing stored program instructions stored in one or more memories for performing the functions that are described herein. In other words, all functions described herein are intended to indicate operations performed using programming in a special or general-purpose computer, in various embodiments. FIG. 1A illustrates only one of many possible arrangements of components configured to execute the programming described herein. Other arrangements may include fewer or different components, and the division of work between the components may vary depending on the arrangement.

FIG. 1A, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In one embodiment, a server computer 110 hosts a supply chain network analysis application 112 and is communicatively coupled to one or more user computers 170, a dynamically generated LLM agent graph 120, supply chain planner instructions 140, a supply chain database 150, and data storage 160. In an embodiment, the server computer 110 may be a computer system hosting the supply chain analysis application 112. Each user computer 170 may comprise a desktop computer, workstation, laptop computer, tablet computer, or other mobile computing device such as smartphones. For purposes of illustrating a clear example, FIG. 1A shows one user computer 170, but embodiments of system 100 may be configured with sufficient central processing unit (CPU) power and storage to support thousands to millions of user computers in client-server sessions with the server computer 110. In various embodiments, the server computer 110 may comprise any of one or more rack-mounted servers, server clusters, processor clusters, and/or virtual compute instances and virtual storage instances on-premises at an enterprise or cloud-based in a virtual computing center of a service provider.

The server computer 110 may be programmed to execute supply chain analysis application 112. The supply chain analysis application 112 may comprise a plurality of sets of stored program instructions organized as a constraint programming (CP) orchestrator 114, presentation instructions 116, and complexity evaluation instructions 118.

The CP orchestrator 114 is programmed to execute planning and optimization and receives a formal meta-problem representing the overall analysis or design task and time, compute, and accuracy constraints. In one embodiment, CP orchestrator 114 is programmed as a CP solver that optimizes the meta-objective using constraint programming methods. The CP orchestrator 114 may be programmed to explore possible sequences of actions and allocations of those actions to available agents under constraints to find an optimal or feasible plan. The CP orchestrator 114 may be programmed to ensure all prerequisites and dependencies between tasks are satisfied and optimizes criteria such as solution completeness, time, or cost. If a feasible plan is found the agent graph 120 is dynamically generated. If no feasible plan can be found given the constraints, the CP orchestrator 114 may be programmed to output an infeasibility indication, which the system can use to report failure or trigger constraint relaxation or alternative problem formulations. For example, the CP orchestrator 114 may output an infeasibility indication when certain required analyses are mutually exclusive with available agents and resources.

The CP orchestrator 114 may include a CP or other constrained optimization solver configured to receive a meta-level model of analysis tasks and to output an optimized plan of operations and agent assignments. Alternatively, the CP orchestrator 114 can be programmed to programmatically call programming solver instructions 130, which implements a solver directly or by invoking agentic LLM operations via the LLM agent graph 120. The agent graph 120 can be a group of agents that further self-coordinate and does not need to be a fixed execution graph.

FIG. 1B illustrates an example graph of programmed agents in an agentic AI approach. In an embodiment, the agent graph 120 represents a plurality of sets of stored program instructions that implement a respective plurality of executable agents comprising program logic, stored prompts or prompt templates, and calls to one or more models such as LLMs or application programming interfaces (APIs). Each agent comprises a set of stored program instructions, typically originally authored in Python using a combination of proprietary code and public libraries, that implements a discrete function including decision logic governing transitions to one or more child nodes representing other agents. In the example agent graph 120 of FIG. 1B, in response to receiving a prompt 122 from CP orchestrator 114, the agent graph 120 invokes at a root node 124 comprising a first agent, and the results of the first agent may direct how to traverse the graph to the next agent. Each agent may be tailored to a particular type of task in the supply chain analysis/design process. Examples may include code generation agents 128, data retrieval/integration agents 126, analytical reasoning agents 180, summarization/reporting agents 184, and code execution agents 182.

Code generation agents 128 may receive instructions and produce executable code to perform data processing and mathematical calculations or to formulate and solve a sub-problem via an optimization library. The instructions could specify an analysis operation, and the executable code could use languages like Python or SQL. A code generation agent may incorporate calls to programming solver instructions 130 within the generated code when tackling a complex planning sub-task. The programming solver instructions 130 could be external CP/MIP solvers. The calls could generate code that uses a MIP solver to optimize a facility location or transportation routing problem.

Data retrieval/integration agents 126 may be programmed to handle communication with databases, APIs, or supply chain software, such as pulling scenario data from supply chain planner instructions 140. Data retrieval/integration agents 126 may ensure each analysis operation has the required input data.

Analytical reasoning agents 180 can be programmed to perform reasoning or calculations directly by programmatically calling one or more public LLM application programming interfaces represented by LLM API 190, including but not limited to performing unit conversions, simple arithmetic, or evaluating logical conditions. Analytical reasoning agents 180 may use the LLM's internal reasoning or call utility functions implemented in the agent or in a library. For purposes of illustrating a clear example, FIG. 1B shows one LLM API 190, but in practice, any of the agents of LLM agent graph 120 can be programmed to call any number of LLMs via the same or different APIs, serially or in parallel. While analytical reasoning agents 180 can leverage test-time compute enhancements of LLM API 190, like multi-step reasoning or external calculator tools to improve accuracy, their reasoning scope is still limited compared to dedicated OR solvers.

In addition, any of the agents of LLM agent graph 120 can be programmed to call a Model Control Protocol (MCP) server 192 to utilize tools or other agents as allocated by CP orchestrator 114.

Summarization/reporting agents 184 may use the natural-language generation ability of LLM API 190 to compile results from various operations into coherent explanations, reports, or visualizations for end users.

Code execution agents 182 may execute the code generated by code generation agent 128 and perform arbitrary calculations and manipulations needed, for example, the execution of Python code to process data or generate visualizations, in addition to writing code to define base optimization models and run optimization solvers. A code execution agent 182 can be programmed based on a library or runtime programmed with functions that the code execution agent can call to query data sources, perform calculations, and invoke solvers. In various embodiments, the runtime could comprise a Python execution environment with libraries like Pandas, OR-Tools, Gurobi, etc. Code execution agents 182 may invoke any required secondary optimization solvers during the execution of tasks.

Referring again to FIG. 1A, presentation instructions 116 may be programmed to provide or generate instructions for rendering a visual front-end for the user to input natural-language queries and to receive results. For example, presentation instructions 116 can include an HTTP server capable of outputting HTML that a browser of the user computer 170 can render to visually display a graphical user interface. The presentation instructions 116 may be programmed to manage integration with external supply chain systems or data sources, such as loading scenario data such as parameters and results from supply chain planner instructions 140 or supply chain database 150 or storing results in the data storage 160. The presentation instructions 116 may communicate the user's query to the CP orchestrator 114 via an initial LLM interpretation and present the final answers or recommendations, possibly enriched with charts or other media, back to the user on the user computer 170.

The supply chain analysis application 112 may include complexity evaluation instructions 118 that may be programmed to compute one or more complexity metrics of intermediate outputs produced by the agents of the agent graph 120. When any complexity metric exceeds a threshold, the complexity evaluation instructions 118 may be configured to trigger an iterative refinement process by instructing the corresponding agent to regenerate the intermediate output, for example to instruct the regeneration of code which, when executed, will produce an output within bounds corresponding to the maximum complexity that can be safely consumed by the next agent in the agent graph 120.

The data storage 160 may store intermediate results, historical analysis outcomes, or learned patterns. The CP orchestrator 114 and agents can utilize stored information in the data storage 160 to improve planning efficiency or provide context, for example, by reusing previous computation results if applicable. The data storage 160 is also used to capture values to use for learning predictive models for each agent of its complexity bounds, expected run time, cost and accuracy.

### 2.2 Functional Workflow

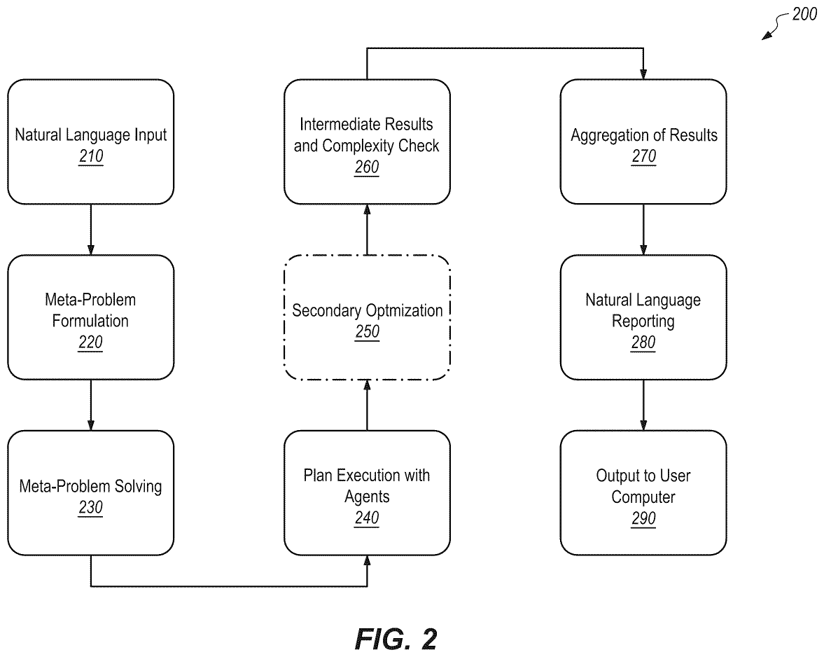

FIG. 2 illustrates an example of a functional workflow for supply chain design and planning with bounded reasoning that can be executed in one embodiment. FIG. 2 represents one possible sequence of operations that the agents of the agent graph 120 may execute depending on the nature of the input, query, or prompt received from the user computer 170.

In an embodiment, at block 210, a natural-language input is received. For example, the execution flow 200 begins execution in response to receiving a natural language query regarding a supply chain design or planning problem from user computer 170 (FIG. 1A). For example, the query may ask for comparing multiple scenarios, identifying bottlenecks, optimizing certain aspects of the network, or other high-level analytical tasks across scenarios or design alternatives.

At block 220, a meta-problem formulation is generated. For example, CP orchestrator 114 may be programmed to call an analytical reasoning agent 180 of the design-time agent graph 120 programmed as an LLM-based agent to assess a list of available agents that would potentially be required to answer the request given the available data in the supply chain database 150 and the possible need for additional agent instances and types to gather new data required to answer the question including services available via MCP sever 192. Alternatively, CP orchestrator 114 may be programmed to call an analytical reasoning agent 180 of the design-time agent graph 120 programmed as an LLM-based agent to interpret the request from user computer 170 and automatically formulate and store in data storage 160 a formal meta-level optimization model representing the tasks required. The meta-level optimization model may include decision variables corresponding to potential analysis operations, constraints encoding logical dependencies, and coverage of the query's requirements. For example, a logical dependency could specify that certain computations should precede comparisons. The meta-problem may encapsulate how to structure the analysis rather than the direct answer.

At block 230, meta-problem solving executes. In an embodiment, CP orchestrator 114 receives the meta-level model and solves it using constraint programming or another constrained optimization technique. The result may be an optimized plan, including an ordered sequence of analysis operations, with each operation assigned to one or more agents of the run-time agent graph 120. The optimized plan may act as a high-level program to guide other execution of the elements of FIG. 1A, FIG. 1B. The solver may ensure the plan is feasible and often optimize one or more objectives like minimizing the number of steps or total estimated computation time. Feasibility, in this context, can mean that all prerequisites for each operation are met in sequence to satisfy required overall accuracy, compute time or compute cost. When no valid sequence of operations can satisfy the query given available agents and constraints, the CP orchestrator 114 can be programmed to report a failure or request to relax certain requirements rather than attempt a likely incorrect analysis with the API 190 and/or agent graph 120 alone.

At block 240, the system may conduct plan run-time execution with one or more agents, such as the agents of the run-time agent graph 120. In an embodiment, CP orchestrator 114 invokes a corresponding LLM agent of the agent graph 120 or a specialized module to perform each analysis operation in the plan.

In one embodiment, executing an analysis operation may include generating and running code to analyze supply chain data or solve a sub-problem. In cases where a particular analysis operation itself requires solving a formal optimization sub-problem, a code generation agent 128 can be programmed to incorporate a call to a secondary CP or MIP solver via programming solver instructions 130, to handle that optimization, as specified in the plan. This two-tier execution may ensure that appropriate algorithms optimize heavy-duty tasks while another agent of the agent graph 120 focuses on translation, integration, and interpretation tasks. An example of a formal optimization sub-problem is computing an optimal inventory allocation or routing.

At block 250, CP orchestrator 114 is programmed to optionally perform secondary base-level supply chain optimization. In an embodiment, if an analysis operation involves solving a supply chain planning or design sub-problem is identified in the plan, the code generated by the code generation agent 128 will call an external CP or MIP solver via programming solver instructions 130 to obtain an optimal solution for that sub-problem. For example, if the operation is to “determine optimal inventory levels under constraints,” the LLM-generated code may formulate a linear program and invoke a solver to get the results. Using a solver within the task prompted to the code generation agent 128 may ensure that even sub-problems of high complexity are solved to optimality or near-optimality rather than relying on the limited internal reasoning of the API 190. The code generation agent 128 then interprets or formats the solver's output for use in subsequent operations.

At block 260, the complexity evaluation instructions 118 may be programmed to perform intermediate results and complexity checks throughout the course of the run-time operation. The complexity evaluation instructions 118 may evaluate the complexity of one or more intermediate outputs 194 received from the agent graph 120 in real-time using one or more complexity metrics to ensure the output remains within the next agent's reasoning bounds. After each analysis operation is executed using analytical reasoning agent 180, the agent graph 120 returns to the CP orchestrator 114 one or more intermediate outputs 194 comprising numerical outputs, data tables, or textual explanations. If an intermediate output 194 is determined to be overly complex or verbose, for example, by having excess information content or length, the complexity evaluation instructions 118 may be programmed to trigger an iterative refinement to simplify the intermediate output 194 before returning or programmatically transmitting a final output. In addition to inter-agent complexity checking, in one embodiment, the iterative refinement comprises programmatically calling the summarization/reporting agent 184 to reformat or distill information content or structure. The iterative refinement may guarantee that each intermediate result stays within the manageable scope for the following operations or the final reporting, preventing the propagation of unwieldy content that could confuse subsequent LLM processing or the end user.

At block 270, the CP orchestrator 114 may be programmed to perform aggregation of results. Once all operations are executed with each intermediate output 194 verified within complexity bounds, the CP orchestrator 114 can be programmed to call an agent of the agent graph or execute code internal to the CP orchestrator 114 to aggregate results from one or more analysis operations. The aggregation of results may comprise collecting numerical findings, insights that have been identified, and computed comparisons into a structured summary. In an embodiment, the CP orchestrator 114 can be programmed to call the summarization/reporting agent 184 of the agent graph 120, or a different, special-purpose agent programmed to collect results and form a structured summary.

At block 280, the CP orchestrator 114, alone or interoperating with presentation instructions 116, is programmed to a final output 195 using natural language reporting. In one embodiment, block 280 comprises programmatically calling the summarization/reporting LLM agent 184 with a prompt to compose a final report or answer in natural language using the distilled results, resulting in final output 195. The final output 195 can be comprehensive and reliable because each input to the summarization/reporting agent 184 has been complex, bounded, and verified. For example, key computations can be done by formal methods when needed. The natural-language reporting may explain the analysis findings, compare scenarios as requested, and provide reasoning for conclusions. For example, a report can highlight which factors led to cost differences or service level changes between scenarios.

At block 290, the presentation instructions 116 are programmed to present the final output 195 to the user computer 170. The presentation instructions 116 can be programmed to provide the final output 195 via a user interface on the user computer 170. The final output 195 may include charts, tables, or bullet points produced by the summarization/reporting agent 184 to enhance clarity. If the CP orchestrator 114 had earlier determined no feasible plan or certain analyses could not be completed, the final output 195 would instead explain the issue. For example, the final output 195 can specify that the question could not be answered under the given constraints.

### 2.3 Hierarchical Multi-Level Optimization

The computer system of FIG. 1A, LLM agent graph 120 of FIG. 1B and execution flow 200 of FIG. 2 can execute conceptually according to a hierarchical optimization structure in which planning and execution occur at multiple logical levels of program execution with feedback between them.

The hierarchical optimization structure may include an agent execution level or task level. At this logical level, an agent of the agent graph 120 may execute each task in the orchestrated plan. Many tasks involve straightforward data processing or querying, and agent(s) of the agent graph 120 can handle the tasks directly. However, for certain tasks, the complexity of these tasks may approach that of a traditional optimization problem. In these cases, as noted, the agent may effectively generate and solve a sub-problem, often by leveraging a CP or MIP solver within its code. For example, consider a task like “determine optimal inventory levels for each facility in scenario A under cost and service constraints.” The code generation agent 128 may translate the task into a linear programming model and call an MIP solver via programming solver instructions 130. The linear programming model can specify attributes such as an objective of minimizing cost, and constraints for service levels and capacities. In an embodiment, the agent is not programmed to conduct heavy optimization but to orchestrate another layer of optimization by preparing the problem for a solver. The solver may then solve that task, which the agent can interpret, or format as needed. This constitutes a second level of optimization beneath the top-level planner.

The hierarchical optimization structure may include a level of bounded LLM reasoning. While LLM agents can perform some reasoning and iterative self-refinement by running code or using scratchpad memory, their capacity is limited relative to formal solvers. The system disclosed herein may leverage any enhanced reasoning techniques available to the LLM agents at execution time. For instance, the analytical reasoning agent 180 may break a calculation into sub-operations or verify an answer by double-checking with another query. These techniques may be heuristics that improve the reliability of the LLM agent on its specific task. However, these techniques may not equate to the systematic search or proof of optimality that the CP or MIP solvers provide. Thus, the hierarchy may ensure that critical decision-making and optimization are handled by the components best suited for them. In other words, the CP orchestrator 114 is at the meta-level, OR solvers are at the sub-problem level, and the LLM agents of the agent graph 120 connect the CP orchestrator 114 and OR solvers handle unstructured aspects of the tasks.

The multi-level approach of optimization described in this section synergizes the benefits of the CP orchestrator 114 and the dynamic agent graph 120. The CP orchestrator 114 may enforce global coherence and optimality to the multi-operation analysis at the top logical execution level. A single agent of the agent graph 120 may violate global coherence and optimality due to its limited context window. The agents of the agent graph 120 can interface with various data sources, generate code for analytics or solver calls, and articulate findings in human-friendly ways based on the CP orchestrator's 114 blueprints. The result is a system that can take an open-ended supply chain question and deliver a well-structured, optimized analytical procedure and outcome, with each operation being executed by a learning-based or algorithmic method for that operation.

### 2.4 Complexity Metrics and Enhanced Reliability Mechanisms

To keep the LLM-driven reasoning and outputs within safe and manageable bounds, the complexity evaluation instructions 118 may be programmed to utilize a set of advanced complexity metrics to evaluate intermediate results. Each complexity metric may capture a different aspect of output complexity, and together, they can help quantify the risk of hallucinations or misinterpretation arising from overly complex content being received by a subsequent agent. Example complexity metrics and their roles are described as follows.

KOLMOGOROV COMPLEXITY. Kolmogorov complexity measures the absolute information content of an output by estimating how succinctly it can be described. In practice, Kolmogorov complexity can be approximated by assessing the compressibility of the text, that is, the length of the shortest description or program that could generate it. A higher Kolmogorov complexity indicates the output is information-rich or contains intricate details and thus is less repetitive or compressible. For example, a raw data dump of supply chain transactions might have high Kolmogorov complexity because it includes many unique details. In contrast, a summary of that data, which compresses the information into general trends, would have a lower Kolmogorov complexity. By measuring the Kolmogorov complexity, the complexity evaluation instructions 118 can gauge whether an intermediate result is overly detailed or complex in content. Extremely high Kolmogorov complexity in the intermediate output 194 of an agent of the agent graph 120 may signal that the content is too granular or verbose, which could overwhelm the reasoning capacity of API 190 or the user's ability to understand, thereby increasing the chance of errors or misinterpretation.

TRANSFORMER PERPLEXITY. Transformer perplexity reflects the difficulty of the output from the perspective of a language model and can be viewed as determining how greatly the text “surprises” an LLM. In an embodiment, complexity evaluation instructions 118 may compute the transformer perplexity of the intermediate output 194 using the API 190 or the same LLM agent of the agent graph 120 by checking how well the model can predict the sequence. A low transformer perplexity means the text is easy for the API 190 to predict; for example, the text may comprise common or straightforward language. In contrast, a high transformer perplexity means the text is unusual or complex for the LLM addressed via the API 190. For instance, if an intermediate output 194 is written in a convoluted language or includes jargon and numeric patterns that the LLM did not anticipate, the transformer perplexity may be high. A high transformer perplexity suggests that the content might be challenging for even the LLM to follow or could be outside its training distribution, which can be a potential sign that the LLM may have hallucinated some of it or that the LLM may misunderstand it upon reuse. Thus, transformer perplexity indicates content that is difficult for the LLM itself to process, flagging it for simplification.

CONTEXTUAL INFORMATION DENSITY. This metric captures how tightly packed the information is in the output by analyzing the relationships and dependencies between tokens in context. Tokens, in this context, can be words, sub-word elements like n-grams, or symbols. A high contextual information density means that each part of the text carries a lot of contextual linkage with other parts, for example, sentences with many cross-references, embedded clauses, or dense technical descriptions where every term relates to others. In contrast, a more structured explanation, with shorter sentences focusing on one idea at a time, would have a lower contextual information density. Consider an intermediate output 194 that describes a complex cause-and-effect chain in a single long paragraph. The intermediate output 194 might mention multiple interwoven facilities, routes, and metrics. This would yield a high contextual density, as understanding any piece requires interpreting several others simultaneously. Contextual information density may help the system identify such cases of tightly interwoven information. If contextual information density is too high, there can be an elevated risk that the LLM could lose track of the relationships, possibly leading to confusion or misinterpretation. The complexity evaluation instructions 118 can be programmed to break the information into simpler, modular chunks or sentences.

NUMERICAL MAGNITUDE SPECTRUM. This metric reflects complexity arising from numerical data by examining the distribution and scale of numbers present in the output. Supply chain analyses often involve numeric results like cost figures, quantities, or percentages. The numerical magnitude spectrum captures traits like the range of values, their orders of magnitude, and any anomalies. For example, an intermediate output that lists inventory levels might contain values from single digits to millions. Such a wide range may increase the spectrum width. As another example, an intermediate output 194 might mix huge cost figures with small percentage changes. If the numerical magnitude spectrum is too broad or has outliers, it could indicate a unit conversion error or simply data that is hard to summarize in one scale. Unit conversion errors, in particular, are known to comprise a source of error for LLMs. By detecting an unusual numerical magnitude spectrum, complexity evaluation instructions 118 can normalize numbers or flag potential errors. Normalizing numbers could comprise, for example, expressing all values in millions of a currency. In essence, the numerical magnitude spectrum ensures that numeric information is presented in a balanced way that the LLM can handle without misinterpreting relative scales or significance. Similarly, if numerical coefficients are not scaled to similar orders of magnitude this gives rise to numerical problems during MIP solves.

TOKEN COUNT. As a straightforward measure of length, token count indicates the total number of tokens in the output. Token count ensures the content size is within the LLM's workable context window and the user's reasonable reading length. Even if a long intermediate output 194 is informative, the subsequent operations may not process such a long output correctly, or the user may be overwhelmed. For example, an intermediate output 194 of a 5,000-token-long text exceeds the context limit of many LLMs, meaning the intermediate output 194 cannot be transmitted in a prompt for the next reasoning operation or summarization. By monitoring token count, complexity evaluation instructions 118 can enforce that intermediate results are broken up or summarized before they become too lengthy. On the flip side, the token count also ensures outputs are not unnaturally short or empty, which could indicate the LLM failed to produce a valid result. In summary, token count keeps the output manageable: large enough to contain necessary details but not too large to be un-processable.

Each of the above complexity metrics plays a distinct role in evaluating an intermediate result. These complexity metrics may provide a quantitative profile of the output's complexity. The complexity evaluation instructions 118 can be programmed to estimate the risk of hallucination or misinterpretation by examining the quantitative profile. For instance, an intermediate output 194 with high Kolmogorov complexity and transformer perplexity may contain much novel, model-challenging information, indicating the LLM was straining and potentially injecting unsupported content. If contextual information density is high simultaneously, the intermediate output 194 has information that is densely packed and hard to untangle, compounding the risk that either the LLM or the user will misunderstand it. An unusual numerical magnitude spectrum may signal a subtle error, like a hallucinated number or a mis-scaled figure, which could lead to incorrect conclusions if not corrected. Finally, an excessive token count indicates the intermediate output 194 is too voluminous to handle reliably.

By quantifying these aspects, complexity evaluation instructions 118 do not rely on guesswork to identify problematic outputs. Instead, complexity evaluation instructions 118 are programmed with concrete metrics that signal “this result might be too complex or confusing.” When those signals exceed predetermined thresholds, the complexity evaluation instructions 118 may execute actions to simplify or verify the content. In this way, the complexity metrics act as sentinels against LLM limitations, helping maintain the accuracy and clarity of the analysis throughout the multi-operation process. Furthermore, using the above complexity metrics, supply chain analysis application 112 can implement an iterative feedback loop to reduce complexity, dynamically adjusting intermediate output 194 to stay within the LLM's limitations when necessary. With the iterative feedback loop, the supply chain analysis application 112 is programmed to simplify or distill overly complex intermediate output 194 while preserving all decision-relevant information, preventing both model overload and oversimplification. This is achieved by treating certain agents of the agent graph 120 not as problem solvers but as agents configured to distill or aggregate the content or structure of the outputs.

In certain embodiments, after an agent in the agent graph 120 produces an intermediate output 194, the CP orchestrator 114 is programmed to programmatically call complexity evaluation instructions 118 to check the complexity metrics for that output. The CP orchestrator 114 can be programmed to trigger a refinement process if one or more complexity metrics exceed threshold values indicating the content may be too complex or lengthy. An LLM output distiller agent of the agent graph 120 may be tasked with compressing or restructuring the output. This agent may be prompted to “summarize the above results,” “simplify the language and retain key points,” or rewrite the content to reduce complexity. Because the LLM output distiller agent calls the API 190, the agent can understand the content and intelligently condense it rather than just truncating text.

After this output distillation, the complexity metrics are recalculated on a new version of the intermediate output 194. If the complexity metrics still indicate excessive complexity, the refinement step repeats, possibly with adjusted instructions, for example, further summarization or splitting the content into bullet points. This feedback loop continues iteratively until the output's metrics fall within acceptable bounds, which means the content is now concise and clear enough for reliable downstream processing.

The iterative reduction process would not oversimplify the results. The supply chain analysis application 112 can enforce constraints during refinement to keep essential data intact. For example, an LLM output distiller agent of the agent graph 120 may be prompted to maintain all quantitative findings and proper nouns while condensing explanatory text, guided using the complexity metrics. For example, if the intermediate output 194 becomes too simple, where a low Kolmogorov complexity indicates a loss of information, the CP orchestrator 114 and/or complexity evaluation instructions 118 can be programmed to stop iterating further or adjust the approach. Therefore, embodiments can be programmed to balance the intermediate output 194 to be as simple as necessary but no more straightforward.

The iterative feedback loop described above may not only correct any AI coding errors but also monitor in the loop the complexity (using the deterministically computed complexity measures) of the output created by code execution (within the agent). If the execution output is too complex to be able to be consumed without hallucination by the next LLM analysis operation or LLM agent, an LLM code generation agent may be instructed to rewrite the code again in a way that the new version of the code, when run, produces simpler output that can still be used to answer the question but in a more efficient way with a smaller textual or data output (such as through different aggregations, higher level representations, etc.). Therefore, each agent can always self-adjust its output to not overwhelm the (reasoning) limits of the next LLM (which will then turn that textual or data output into tokens, etc.).

An example of supply chain analytics processing is now described. Assume that a supply chain network analysis operation compares the costs of dozens of facilities across two scenarios, resulting in an intermediate output 194 comprising a detailed table or lengthy explanation for each facility. The intermediate output 194 may be very high in Kolmogorov complexity with many unique data points, high in token count and thus lengthy, and perhaps high in numerical magnitude spectrum by having a wide range of cost values. Directly feeding the intermediate output 194 into the summarization/reporting agent 184 or presenting it to the user computer 170 could cause the model to lose track of important points or overwhelm the end user with details.

In an embodiment, the CP orchestrator 114, complexity evaluation instructions 118, and agent graph 120 are programmed to execute iterative complexity reduction as follows. The intermediate output 194 listing all facilities and their cost differences may be transmitted to an LLM output distiller agent with a prompt like, “Summarize the key cost difference drivers between the scenarios. Focus on the largest contributors and group similar facilities together.” The LLM agent may then produce a condensed summary as a second intermediate output 194. For example, the condensed summary may be “Out of 50 facilities, the top 3 contribute 80% of the total cost difference between Scenario A and B. Facility X has the highest cost increase (+$2 M in Scenario A), largely due to higher transportation expense. Most other facilities have minor cost differences (4100k).” This summary would drastically reduce token count and Kolmogorov complexity by focusing on the high-level insight, specifying that three facilities account for most differences, rather than every data point, and it would restrain the numerical magnitude spectrum by normalizing mention of more minor differences.

The complexity evaluation instructions 118 may be programmed to check the complexity metrics of the second intermediate output 194. If the complexity metrics are now within bounds, processing ends. The key information that a few facilities drive the cost gap may be preserved. None of the decision-critical insights are lost, but the clutter of fewer essential details is removed. The next agent can receive the second intermediate output 194 and incorporate it into the final output 195 without being sidetracked by an overload of data. In this way, an embodiment programmed to use iterative complexity reduction can prevent data overload in complex analyses while maintaining the integrity of the conclusions.

A parallel execution and consensus mechanism using multiple agents adds another layer of reliability. Instead of relying on a single agent's output for a particular operation, the CP orchestrator 114 can deploy multiple agents in parallel to perform the same task and cross-verify the results. By calling the agent graph 120 or using the code of CP orchestrator 114 for comparing the intermediate outputs 194 from different models or multiple runs of the same model, the CP orchestrator 114 can detect hallucinations and inconsistencies, thereby boosting overall accuracy.

When multiple agents tackle the same problem independently, any hallucinated fact or logical error will likely appear in only one model's output and not the others. The CP orchestrator 114 can be programmed to aggregate the outputs and check for agreement. In an embodiment, if all or most of the models produce the same answer or description, the CP orchestrator 114 is programmed to confirm that the result is correct since multiple models are unlikely to hallucinate the same detail. Conversely, if one model's answer deviates significantly, then the CP orchestrator 114 may be programmed to flag the discrepancy. In this context, the CP orchestrator 114 can be programmed to detect a significant deviation, for example, if three models agree on a particular root cause for a problem but a fourth model suggests an entirely different reason. Such a disagreement signals the divergent intermediate output 194 may contain a hallucination or error. In response, in one embodiment, the CP orchestrator 114 is programmed to discard the outlying answer and trust the consensus of the others or prompt a follow-up verification by prompting another question to the models via the agent graph 120 or by using a more formal check to determine which answer is correct.

Running multiple models in parallel can also enable the system to assign an implicit confidence score to the results. Essentially, the level of agreement between the independent agents is a measure of confidence. For example, if five out of five models produce an identical summary of a scenario comparison, the system can be programmed to record that the summary is accurate. As another example, if three out of five models agree and two differ in minor ways, the CP orchestrator 114 can be programmed to record that confidence is moderate and to include only the points consistently mentioned by the majority. Further, if every model's output is significantly different, the system may be programmed to determine that the task is ambiguous or too complex, and, in response, to invoke a more robust model, divide the task, or transmit a notification to the user's computer 170 specifying an uncertainty. Programming a consensus approach as described above can provide a built-in validation step for the LLM-generated content without needing external ground truth as the models validate each other.

In an embodiment, the consensus approach described herein does not require using multiple large-scale models in parallel, which could be computationally expensive. In an embodiment, the CP orchestrator 114 can be programmed to call and use an ensemble of smaller, less costly LLMs via API 190 to achieve a similar effect. For example, instead of one 100-billion-parameter model, the CP orchestrator 114 may be programmed to transmit prompts to three different 10-billion-parameter models or to the same 10B model via API 190 using different random seed values or prompt variations and to assess concurrence of the responses. Each smaller model may have a higher individual chance of error, but the chance that all make the same error is lower. Thus, if these smaller models agree, the intermediate output 194 is likely correct. An ensemble strategy can be more cost-effective and faster due to parallelism while maintaining high reliability. In certain embodiments, the CP orchestrator 114 is programmed to use a coordination layer that sends a given analysis query for a particular operation to multiple instances of agents in agent graph 120 simultaneously and compares their responses.

The iterative feedback loop, together with the use of parallelism and consensus of results across the parallel executions of iterative feedback loops, can be used to minimize hallucination.

Parallel model execution can resolve supply chain scenarios as specified in the following examples. Consider an analysis task to explain the cause of a surprising increase in logistics cost in Scenario A compared to Scenario B. With such an open-ended explanatory task, an LLM agent may fabricate a plausible but inaccurate reason. In an embodiment, the CP orchestrator 114 is programmed to obtain three independent explanations using one or more agents of the agent graph 120 to execute three parallel calls to different models vial API 190. Suppose two intermediate outputs 194 respectively received from two different LLM calls or agents cite a common factor like “higher fuel prices in Scenario A's timeframe,” but a third intermediate output 194 from a different agent or model cites “a warehouse closure in Scenario A.” The CP orchestrator 114 can be programmed to determine that the third explanation is an outlier not supported by the other two agents and, in response, to check the data for any mention of a warehouse closure. If none exists in the input data, the check confirms the third intermediate output 194 as hallucinating. Therefore, in response, the CP orchestrator 114 can be programmed to select or accept the fuel price explanation agreed upon by the two agents. The final report to the user may include a well-supported reason and omit the spurious one.

Another scenario may comprise calculating a complex performance metric that is not explicitly stored in the data but can be derived. One LLM agent may make a calculation mistake, but if two other agents calculate it correctly and agree on a number, the CP orchestrator 114 may be programmed to detect one odd result and exclude it.

Through these parallel executions, the accuracy and robustness of the analysis in decision-making situations can be significantly improved. The user computer 170 can receive final output 195 that has effectively been “peer-reviewed” by multiple agents, with any contentious points resolved or highlighted as uncertain. This consensus mechanism thus can safeguard against individual model errors, ensuring that decisions on supply chain planning are based on reliable, verified information.

### 2.5 Example Use Case

As an example of system operation in accordance with FIG. 2, assume the CP orchestrator 114 receives from user computer 170 the following query: “Compare the total cost, service level, and CO₂ emissions between two supply chain scenarios (Scenario A and Scenario B) from our recent design simulations. Analyze the network flow changes, identify key differences in facility usage and transportation routes, determine the main cost drivers for each scenario, and assess the impact on service levels and environmental factors.” In response, the CP orchestrator 114 is programmed to interpret the query as requesting a series of analyses on two scenarios and comparisons between them. The CP orchestrator 114 is programmed to formulate a meta-problem, which includes variables and constraints to ensure that the value is calculated for both Scenario A and Scenario B for each metric, like total cost, service level, and CO2 emissions before a comparison operation is completed. The meta-problem may also include operations for analyzing network flows for each scenario, identifying differences between the scenarios, analyzing cost drivers, and evaluating service level and environmental impacts for each scenario. All these operations may need to be completed. The CP orchestrator 114 may be programmed to ensure that prerequisites like “metrics must be calculated before comparison” are encoded. The objective may be to minimize the total number of operations or to find any feasible plan covering all requested analyses. In the example, the query explicitly lists everything needed.

The output of the CP orchestrator 114 may be one feasible plan that the programming solver instructions 130 can solve, and the plan is likely optimal in terms of minimal operations. For example, the plan may include the following sequence of operations:
1. Calculate the total cost for scenario A (assigned to a code generation agent);
2. Calculate the total cost for scenario B (assigned to a code generation agent);
3. Calculate the total cost between scenario A and scenario B (assigned to an analytical reasoning agent or code agent);
4. Calculate the service level for scenario A (code generation agent);
5. Calculate the service level for scenario B (code generation agent);
6. Compare service level between scenario A and scenario B (analytical agent);
7. Calculate CO₂ emissions for scenario A (code generation agent);
8. Calculate CO₂ emissions for scenario B (code generation agent);
9. Compare CO₂ emissions between scenario A and scenario B (analytical agent);
10.Analyze network flow for scenario A (code generation agent);
11.Analyze network flow for scenario B (code generation agent);
12. Identify key differences between scenario A and scenario B (analytical/code agent);
13.Analyze cost drivers for scenario A (code generation agent, possibly invoking an optimization solver if needed);
14.Analyze cost drivers for scenario B (code generation agent);
15.Evaluate service level impact for scenario A (analytical agent);
16.Evaluate service level impact for scenario B (analytical agent);
17.Assess environmental impact for Scenario A (analytical agent);
18.Assess the environmental impact for scenario B (analytical agent).

The above plan logically covers all aspects mentioned in the query. Operations 1-9 may ensure the three key metrics of cost, service level, and emissions are each calculated for both scenarios and then compared. Operations 10-11 can gather more profound insights into each scenario's network flows, which can be used in Operation 12 to identify differences. Operations 13-18 may execute other detailed analyses for each scenario like cost drivers, service, and environmental impacts.

The plan then is executed using one or more agents of the agent graph 120, including code generation and analysis. The agents of agent graph 120 may implement representative operations as follows. Operations 1, 2, 4, 5, 7, and 8 may be associated with calculating metrics. The code generation agent 128 is programmed to generate a script or query to retrieve the metric from outputs from a supply chain design software or calculate it from available data. For example, the code generation agent 128 may query a database of scenario results for “total cost” or compute service level from shipment and demand data. The code execution agent 128 may run this code and obtain the numeric values.

Operations 3, 6, and 9 may be associated with comparisons. The analytical reasoning agent 180 is programmed to obtain the values from the prior calculations and directly compare them, producing a qualitative result, for example, “Scenario A has a 10% higher total cost than Scenario B,” and store the difference or ratio for reporting. These operations can be straightforward once the data is available.

Operations 10 and 11 may be associated with network flow analysis using the same or different code generation agent 128. The code generation agent 128 may generate Python code utilizing, for example, the Networkx library to construct graph models of each scenario's distribution network from the data, including facilities and routes with their flows. This code may calculate centrality measures or identify flow bottlenecks. An example code snippet may be:
pandas as pd
import network as nx
#Assume we have data frames flow_data_A and flow_data_B for the two scenarios
G_A=nx. DiGraph()
for _, row in flow_data_A. iterrows():
   G_A.add_edge(row[‘source’], row[‘destination’],
weight=row[‘flow’]
#(Similar construction for G_B)
centrality_A=nx.degree_centrality(G_A)
centrality_B=nx.degree_centrality(G_B)
#. . . (Compute other network statistics as needed)

The above code snippet is programmed to create and store graph representations and compute degree centrality for each scenario's network. The results, such as lists of essential nodes or heavily used routes, may be saved for the next operation.

Operation 12 may identify key differences. A code generation agent 128, which could be the same code agent specified above or a different one, may compare the results from the two network analyses. The code generation agent 128 may generate code or use logic to find differences in routes used, significant changes in flow on shared routes, or differences in the centrality of certain facilities, outputting a structured summary of differences. An example summary is “Route X−>Y exists in Scenario B but not in A,” “Facility Z has significantly higher throughput in A than in B.”. The code generation agent 128 may produce an intermediate output 194 like a list of new versus removed routes and changed flow volumes between the two scenarios, highlighting the differences as requested.

Operations 13 and 14 may be associated with cost driver analysis for each scenario. An analytical reasoning agent 180 programmed to execute cost analysis can fetch cost breakdowns by category from each scenario's data, from supply chain database 150 or data storage 160, or simulate removing each cost component to see its impact. If the task is to optimize cost drivers and not just analyze them, the code generation agent 128 may be programmed to create an optimization model to formulate a linear program to reallocate resources in scenario A to minimize cost and determine which constraints bind, thereby identifying the key cost drivers. A secondary call to the programming solver instructions 130 can be used. In the described query, “analyze cost drivers” can be evaluated as interpreting existing data, and a call to the API 190 can cause processing cost component reports directly.

Operations 15-18 may be associated with service level evaluation and environmental impact. These operations may involve straightforward computations or retrievals, for example, comparing service level metrics to targets, summing emissions, and checking against goals, and then an interpretation by a different analytical reasoning agent 180 programmed to read the relevant data and note whether Scenario A or B performs better on each aspect and by how much.

After all the above operations, the summarization/reporting agent 184 may take all these findings, including cost comparisons, service level differences, emissions differences, network changes, key differences in routes, main cost drivers, etc., and generate a comprehensive yet digestible report for the user. For example, the summarization/reporting agent 184 may produce an intermediate output 194 comprising paragraphs stating: “Scenario A incurs a total cost of $X, which is 10% higher than Scenario B's $Y, primarily due to higher transportation expenses. Service levels are slightly lower in Scenario A (95% vs 97%), and CO2 emissions are higher by 5% in Scenario A. The network flow analysis indicates that Scenario B introduced two new routes (Factory 1 to DC 3 and Factory 2 to DC 4) that reduced load on central hub routes present in Scenario A, improving reliability. Key differences identified include a major increase in throughput at Facility Z in Scenario B, suggesting it serves as a new regional hub. In contrast, Scenario A relied more on Facility Y . . . ” and so on, concluding with implications for the business. The final output 195 may provide detailed insights and recommendations at a scale that the query from user computer 170 sought, achieved through the coordinated effort of the CP orchestrator 114 and agents of the agent graph 120.

The embodiments disclosed herein may have several technical advantages for supply chain analysis, design, and planning. One technical advantage may include structured, correct-by-design reasoning. Using a CP orchestrator 114 to plan the analysis operations, the computer system and processing methods of this disclosure can ensure that the overall reasoning process follows a logically valid structure, satisfying all prerequisites and constraints, reducing the risk of LLM hallucinations or logical missteps in multi-step analyses. Each agent of the agent graph 120 can operate within guardrails programmed into the CP orchestrator 114, leading to more reliable outcomes for complex queries. Furthermore, using complexity metrics and iterative refinement means that even within this scaffold, each intermediate output 194 can be checked and kept within manageable complexity, catching potential issues early.

Another technical advantage may include optimized multi-step planning. The system 100 not only automates analysis but also optimizes the approach to analysis. The CP orchestrator 114, interoperating with programming solver instructions 130, can find an order of execution and allocation of tasks to agents of the agent graph 120 that is efficient and meets objectives like minimizing runtime or resource usage. Therefore, the user computer 170 can receive results faster, and the system 100 can scale better to significant problems than a naive or predetermined sequence of operations. The addition of parallel agent execution for key operations can improve efficiency as well. The system 100 can achieve accuracy by allowing smaller models to share the load and verify each other without always resorting to the slowest, largest model for every task.

Another technical advantage may include flexibility and integration. Using agents of the agent graph 120 for task execution can result in high flexibility. The same agent graph 120 can handle various queries, from quantitative comparisons to qualitative assessments, without hard coding each analysis. The agents can be programmed to use existing tools and databases, for example, querying data from supply chain management software and using libraries like Networkx or OR-tools as needed. Therefore, system 100 can augment and work alongside current supply chain analytics platforms rather than requiring a complete replacement. The complexity-bounding techniques ensure that the information flow can remain controlled and coherent even when integrating diverse tools and data.

Another technical advantage may include hierarchical problem-solving. The optimization structure described above with multiple logical levels can allow system 100 to process complex planning problems by breaking them down. The CP orchestrator 114 executing at the top logical level determines analysis operations and their order, while the bottom-level solvers, possibly invoked within code that the code generation agent 128 has generated, determine how to perform the analysis operations optimally. The logical division of processing in levels can ensure that even if an individual sub-problem is highly complex or NP-hard, a specialized algorithm is used for that sub-problem, guided by the ability of API 190 to correctly arrange each sub-problem or algorithm. The result can be a highly scalable and robust system 100 that can solve problems beyond the practical reasoning capacity of an LLM alone. In addition, by bounding the reasoning at each operation with complexity metrics and using consensus checks, the system 100 can maintain robustness even as problem complexity grows, because it self-monitors and adapts its outputs.

Another technical advantage may include a natural language interface with expert-level precision. User computer 170 can interact with system 100 through intuitive natural language queries, but the system can ensure the accuracy and depth of expert analysis in the final output 195. The answers in final output 195 may have the clarity of LLM-generated language and explanations but are grounded in formal optimization results and systematically verified intermediate operations. This combination of ease of use and trustworthy analytical depth means that even non-expert users can pose high-level questions (such as “What if,” “Why is X happening,” and “optimize Y”) and receive answers that are not only easy to understand but also backed by complex computations, data, and logically sound reasoning. Introducing complexity metrics, iterative refinement, and parallel verification further means the final output has been refined and vetted to eliminate standard failure modes of LLMs, giving end-users confidence in the recommendations or insights provided.

### 2.6 Example Process of Schedule Optimization

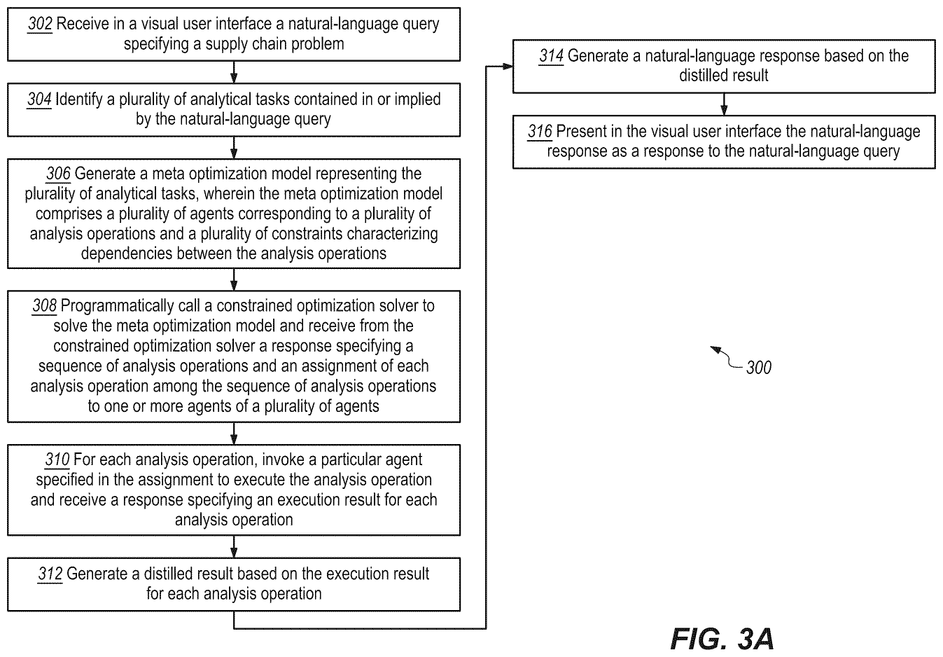

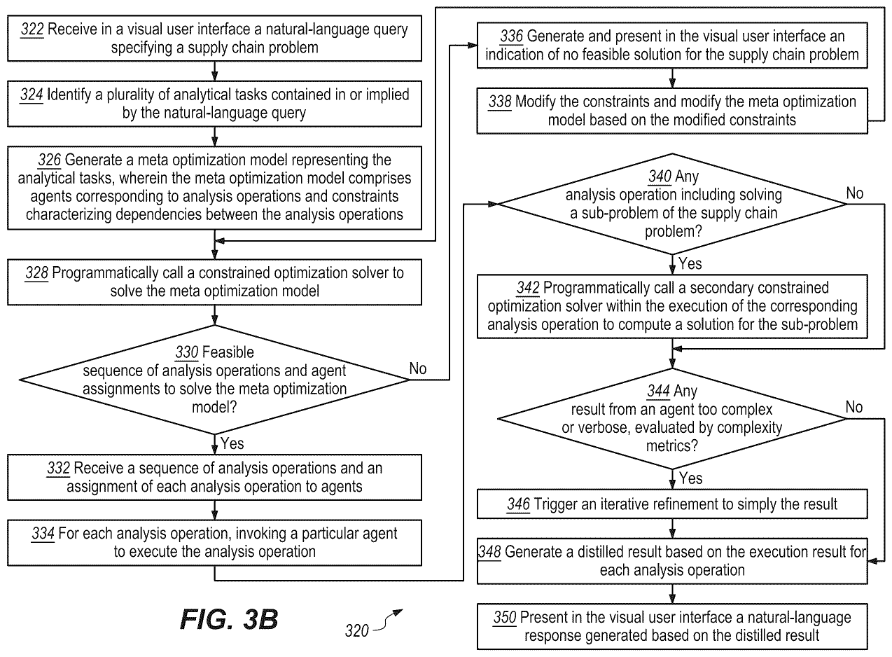

FIG. 3A illustrates a flow diagram of a method for supply chain design and planning with bounded reasoning in accordance with the disclosed embodiments. FIG. 3B illustrates another flow diagram of a method for supply chain design and planning with bounded reasoning. FIG. 3A and FIG. 3B and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In the example of FIG. 3A and FIG. 3B, a first method 300 and a second method 320 may be performed utilizing one or more processing devices (for example, server computer 110 as discussed above with respect to FIG. 1A) that may include hardware (for example, a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing various incident event data and making one or more predictions or decisions based thereon), firmware (for example, microcode), or some combination thereof. Any such embodiment operates under stored program control using the software elements that have been previously described.

Referring first to FIG. 3A, the first method 300 initiates execution at block 302, where the processing devices are programmed to receive, in a visual user interface, a natural-language query specifying a supply chain problem. At block 304, the processing devices are programmed to identify a plurality of analytical tasks contained in or implied by the natural-language query.

At block 306, the processing devices are programmed to generate a meta optimization model representing the plurality of analytical tasks. In one embodiment, the meta optimization model may include a plurality of agents corresponding to a plurality of analysis operations and a plurality of constraints characterizing dependencies between the analysis operations.

At block 308, the processing devices are programmed to programmatically call a constrained optimization solver to solve the meta optimization model and receive from the constrained optimization solver a response specifying a sequence of analysis operations and an assignment of each analysis operation among the sequence of analysis operations to one or more agents of a plurality of agents.

At block 310, the processing devices are programmed to, for each analysis operation, invoke a particular agent specified in the assignment to execute the analysis operation and receive a response specifying an execution result for each analysis operation.

At block 312, the processing devices are programmed to generate a distilled result based on the execution result for each analysis operation.

At block 314, the processing devices are programmed to generate a natural-language response based on the distilled result.

At block 316, the processing devices are programmed to present in the visual user interface the natural-language response as a response to the natural-language query.

Referring to FIG. 3B, method 320 may begin at block 322, where the processing devices are programmed to receive in a visual user interface a natural-language query specifying a supply chain problem.

At block 324, the processing devices are programmed to identify analytical tasks contained in or implied by the natural-language query.

At block 326, the processing devices are programmed to generate a meta optimization model representing the analytical tasks. In one embodiment, the meta optimization model may include agents corresponding to analysis operations and constraints characterizing dependencies between the analysis operations.

At block 328, the processing devices are programmed to programmatically call a constrained optimization solver to solve the meta optimization model.

At block 330, the processing devices are programmed to determine whether there is a feasible sequence of analysis operations and agent assignments to solve the meta optimization model.

If there is a feasible sequence of analysis operations and agent assignments to solve the meta optimization model, method 320 proceeds to block 336. At block 336, the processing devices are programmed to generate and present in the visual user interface an indication of no feasible solution for the supply chain problem.

At block 338, the processing devices are programmed to modify the constraints and modify the meta optimization model based on the modified constraints. Method 300 then returns to block 328, repeats block 328 and block 330.

Method 320 may repeat block 328, block 330, block 336, and block 338 until there is a feasible sequence of analysis operations and agent assignments to solve the meta optimization model.

If there is a feasible sequence of analysis operations and agent assignments to solve the meta optimization model, method 320 proceeds to block 332 from block 330. At block 332, the processing devices are programmed to receive from the constrained optimization solver a response specifying a sequence of analysis operations and an assignment of each analysis operation among the sequence of analysis operations to one or more agents.

At block 334, the processing devices are programmed to, for each analysis operation, invoke a particular agent specified in the assignment to execute the analysis operation.

At block 340, the processing devices are programmed to determine whether any analysis operation includes solving a sub-problem of the supply chain problem. If any analysis operation includes solving a sub-problem of the supply chain problem, method 320 proceeds to block 342.

At block 342, the processing devices are programmed to programmatically call a secondary constrained optimization solver within the execution of the corresponding analysis operation to compute a solution for the sub-problem. Method 320 then proceeds to block 344.

If none of the analysis operations includes solving a sub-problem of the supply chain problem, method 320 proceeds to block 344 from block 340.

At block 344, the processing devices are programmed to determine whether any result from an agent is too complex or verbose, which is evaluated by one or more complexity metrics.

If any result from an agent is too complex or verbose, method 320 proceeds to block 346. At block 346, the processing devices are programmed to trigger an iterative refinement to simply the result from that agent. In one embodiment, an LLM output distillation agent may be tasked with invoking the previous agent to regenerate the intermediate result by compressing or restructuring the result. After regenerating the intermediate result, the complexity metrics are recalculated using the new version of the result. If the complexity metrics still indicate excessive complexity, the refinement step repeats, possibly with adjusted instructions. This feedback loop continues iteratively, and the result is not complex or verbose.

If no result from an agent is too complex or verbose or after the iterative refinement in block 346, method 320 proceeds to block 348. At block 348, the processing devices are programmed to generate a distilled result based on the execution result for each analysis operation.

At block 350, the processing devices are programmed to present in the visual user interface a natural-language response generated based on the distilled result.

### 3. Example Hardware Implementing Mechanism

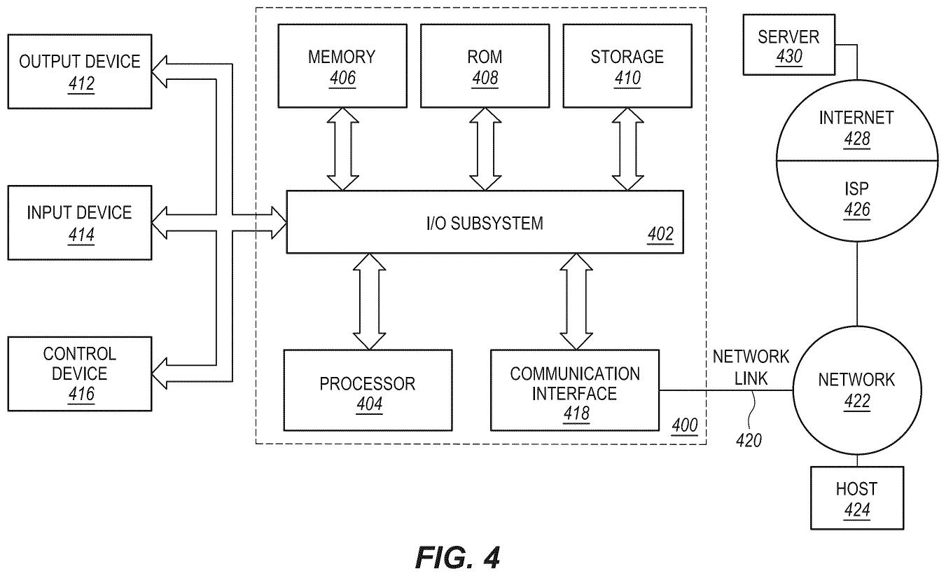

FIG. 4 is a block diagram of an example computer system 400 that may be used in an implementation of supply chain design and planning with bounded reasoning.

Computer system 400 includes bus 402 or other communication mechanism for communicating information and one or more hardware processors coupled with bus 402 for processing information. Hardware processor 404 may be, for example, a general-purpose microprocessor, a central processing unit (CPU) or a core thereof, a graphics processing unit (GPU), or a system on a chip (SoC).

Computer system 400 also includes a main memory 406, typically implemented by one or more volatile memory devices, coupled to bus 402 for storing information and executing instructions by processor 404. Main memory 406 may also be used for storing temporary variables or other intermediate information during the execution of instructions by processor 404. Computer system 400 may also include read-only memory (ROM) 408 or other static storage device coupled to bus 402 for storing static information and instructions for processor 404. A storage system 410, typically implemented by one or more non-volatile memory devices, is provided and coupled to bus 402 for storing information and instructions.

Computer system 400 may be coupled via bus 402 to display 412, such as a liquid crystal display (LCD), a light emitting diode (LED) display, or a cathode ray tube (CRT), for displaying information to a computer user. Display 412 may be combined with a touch-sensitive surface to form a touch-screen display. The touch-sensitive surface is an input device for communicating information, including direction information and command selections to processor 404 and for controlling cursor movement on display 412 via touch input directed to the touch sensitive surface, such by tactile or haptic contact with the touch sensitive surface by a user's finger, fingers, or hand or by a hand-held stylus or pen. The touch-sensitive surface may be implemented using various touch detection and location technologies, including, for example, resistive, capacitive, surface acoustical wave (SAW) or infrared technology.

Input device 414, including alphanumeric and other keys, may be coupled to bus 402 for communicating information and command selections to processor 404.

Another type of user input device may be cursor control 416, such as a mouse, a trackball, or cursor direction keys for communicating direction information and command selections to processor 404 and for controlling cursor movement on display 412. This input device typically has two degrees of freedom in two axes, a first axis (for example, x) and a second axis (for example, y), that allows the device to specify positions in a plane.

Instructions, when stored in non-transitory storage media accessible to processor 404, such as, for example, main memory 406 or storage system 410, render computer system 400 into a special-purpose machine that is customized to perform the operations specified in the instructions. Alternatively, customized hard-wired logic, one or more ASICs or FPGAs, firmware and/or hardware logic which, combined with the computer system, causes or programs computer system 400 to be a special-purpose machine.

A computer-implemented process may be performed by computer system 400 in response to processor 404 executing one or more sequences of one or more instructions contained in main memory 406. Such instructions may be read into main memory 406 from another storage medium, such as storage system 410. Execution of the sequences of instructions contained in main memory 406 causes processor 404 to perform the process. Alternatively, hard-wired circuitry may be used in place of or in combination with software instructions to perform the process.

The terms “computer-readable media” and “storage media,” as used herein, refer to any non-transitory media that store data and/or instructions that cause a machine to operate in a specific fashion. Such storage media may comprise non-volatile media (for example, storage system 410) and/or volatile media (for example, main memory 406). Non-volatile media includes, for example, read-only memory (for example, EEPROM), flash memory (for example, solid-state drives), magnetic storage devices (for example, hard disk drives), and optical discs (for example, CD-ROM). Volatile media includes, for example, random-access memory devices, dynamic random-access memory devices (for example, DRAM) and static random-access memory devices (for example, SRAM).

Storage media is distinct from but may be used in conjunction with transmission media. Transmission media participates in transferring information between storage media. For example, transmission media includes coaxial cables, copper wire and fiber optics, including the circuitry that comprises bus 402. Transmission media can also be acoustic or light waves, such as those generated during radio-wave and infrared data communications.

Computer system 400 also includes a network interface 418 coupled to bus 402. Network interface 418 provides a two-way data communication coupling to a wired or wireless network link 420 that is connected to a local, cellular or mobile network 422. For example, communication interface 418 may be an IEEE 802.3 wired “ethernet” card, an IEEE 802.11 wireless local area network (WLAN) card, an IEEE 802.15 wireless personal area network (for example, Bluetooth) card or a cellular network (for example, GSM, LTE, etc.) card to provide a data communication connection to a compatible wired or wireless network. In any such implementation, communication interface 418 sends and receives electrical, electromagnetic or optical signals that carry digital data streams representing various types of information.

Network link 420 typically provides data communication through one or more networks to other data devices. For example, network link 420 may connect through network 422 to local computer system 424 that is also connected to network 422 or to data communication equipment operated by a network access provider 426 such as, for example, an internet service provider or a cellular network provider. Network access provider 426, in turn, provides data communication connectivity to another data communications network 428 (for example, the internet). Networks 422 and 428 both use electrical, electromagnetic or optical signals that carry digital data streams. The signals through the various networks and the signals on network link 420 and through communication interface 418, which carry the digital data to and from computer system 400, are examples of transmission media.

Computer system 400 can send messages and receive data, including program code, through networks 422 and 428, network link 420 and communication interface 418. In the internet example, a remote computer system 430 might transmit a requested code for an application program through network 428, network 422 and communication interface 418. The received code may be executed by processor 404 as it is received and/or stored in storage system 410 or other non-volatile storage for later execution.

### 5. Extensions and Alternatives

While the foregoing embodiments are described by way of example to improving approval cycle times for purchase requisitions, invoices, or expense reports, one skilled in the art will appreciate from the foregoing description that the embodiments may also applied analogously to other types of approvals in various different approval chains including, but not limited to, those involving inventory management and supplier information management.

In the foregoing detailed description, various embodiments of improving spend approver cycle time in a software-as-service (Sass) electronic spend management system based on community spend approval information have been described with reference to numerous specific details that may vary from implementation to implementation. Accordingly, the specification and drawings are to be regarded in an illustrative rather than a restrictive sense.

What is claimed is:

1. A computer-implemented method executed using a computer system, the method comprising:
receiving in a visual user interface a natural-language query specifying a supply chain problem;
identifying a plurality of analytical tasks contained in or implied by the natural-language query;
generating a meta optimization model representing the plurality of analytical tasks, wherein the meta optimization model comprises a plurality of agents corresponding to a plurality of analysis operations and a plurality of constraints characterizing dependencies between the plurality of analysis operations;
programmatically calling a constrained optimization solver to solve the meta optimization model and receiving from the constrained optimization solver a response specifying a sequence of analysis operations and an assignment of each analysis operation among the sequence of analysis operations to one or more agents of a plurality of agents;
for each analysis operation, invoking a particular agent specified in the assignment to execute the analysis operation and receiving a response specifying an execution result for each analysis operation;
generating a distilled result based on the execution result for each analysis operation;
generating a natural-language response based on the distilled result; and
presenting in the visual user interface the natural-language response as a response to the natural-language query.

2. The computer-implemented method of claim 1, further comprising:
determining at least one analysis operation comprises solving a sub-problem of the supply chain problem; and
programmatically calling a secondary constrained optimization solver during the execution of the at least one analysis operation to compute a solution for the sub-problem.

3. The computer-implemented method of claim 1, wherein each agent of the plurality of agents is configured for a particular type of task, wherein the plurality of agents comprise one or more of a first agent configured for code generation, a second agent configured for data retrieval, a third agent configured for data integration, a fourth LLM agent configured for analytical reasoning, and a fifth agent configured for summarization.

4. The computer-implemented method of claim 1, further comprising, responsive to receiving the natural-language query, programmatically calling a supply chain planner or database and retrieving supply chain data from the supply chain planner or a database, wherein executing at least one of the plurality of analysis operations comprises calling the one or more agents with an input specifying the supply chain data and instructions to execute the at least one analysis operation.

5. The computer-implemented method of claim 1, wherein for at least one analysis operation, invoking the one or more agents to execute the at least one analysis operation comprises:
invoking a first agent to generate code in a programming language for the at least one analysis operation, wherein the first agent is configured for code generation; and
invoking a second agent of the one or more agents to execute the code for the at least one analysis operation, wherein the second agent is configured for code execution.

6. The computer-implemented method of claim 5, further comprising executing the code by programmatically calling a secondary constrained optimization solver to solve an optimization problem associated with the at least one analysis operation.

7. The computer-implemented method of claim 1, further comprising, for each analysis operation, accessing one or more intermediate results from the one or more agents and evaluating an output complexity of the one or more intermediate results from the one or more agents using one or more complexity metrics.

8. The computer-implemented method of claim 7, further comprising:
accessing a first intermediate result of the one or more intermediate results produced by a first agent; and
using the one or more complexity metrics, quantifying an information content and a structure of the first intermediate result and determining a risk of hallucination or misinterpretation in each analysis operation.

9. The computer-implemented method of claim 8, further comprising:
determining that one or more of the complexity metrics for the first intermediate result exceed a predefined threshold; and
invoking the first agent to regenerate the first intermediate result, based on one or more of a simplification or a compression,
re-evaluating the regenerated first intermediate result using the one or more of the complexity metrics, and
repeating the invoking and the re-evaluating until the one or more of the complexity metrics are below the predefined threshold.

10. The computer-implemented method of claim 7, wherein the one or more complexity metrics comprise one or more of Kolmogorov complexity, transformer perplexity, contextual information density, numerical magnitude spectrum, or token count.

11. The computer-implemented method of claim 1, further comprising, for at least one analysis operation, invoking two or more agents among the plurality of agents in parallel to execute the at least one analysis operation;
comparing execution results produced by the two or more agents to detect an inconsistency among the two or more agents or a hallucinated content produced by one agent of the two or more agents; and
executing a consensus algorithm on the execution results to generate a consensual execution result for the at least one analysis operation.

12. The computer-implemented method of claim 11, further comprising determining a confidence score for the consensual execution result based on a degree of agreement between the execution results produced by the plurality of agents.

13. The computer-implemented method of claim 11, further comprising:
executing the consensus algorithm on the execution results produced by the plurality of agents to identify one or more aspects of the execution results having consensus from the plurality of agents; and
selecting the identified one or more aspects of the execution results or synthesizing from the identified one or more aspects of the execution results to generate the consensual execution result.

14. The computer-implemented method of claim 1, wherein the natural-language query specifies comparing a plurality of supply chain scenarios, and wherein the plurality of analysis operations comprise one or more of:
calculating one or more performance metrics for each supply chain scenario of the plurality of supply chain scenarios;
comparing the one or more performance metrics between two or more supply chain scenarios of the plurality of supply chain scenarios;
analyzing network flows or operational details for each supply chain scenario of the plurality of supply chain scenarios;
identifying structural or outcome differences between two or more supply chain scenarios of the plurality of supply chain scenarios;
analyzing contributing factors within each supply chain scenario of the plurality of supply chain scenarios; or
evaluating a respective impact of each supply chain scenario of the plurality of supply chain scenarios.

15. The computer-implemented method of claim 1, wherein the natural-language query specifies comparing a plurality of supply chain scenarios, and wherein the plurality of analysis operations comprise identifying structural or outcome differences between the plurality of supply chain scenarios, the identifying comprising:
for each supply chain scenario of the plurality of supply chain scenarios, generating a scenario model as one or more graphs or structured data, thereby forming a plurality of scenario models;
calculating one or more quantitative measures for each scenario model of the plurality of scenario models based on the one or more graphs or structured data;
comparing the plurality of scenario models based on their respective quantitative measures to detect structural or outcome differences;
identifying one or more changes in the quantitative measures between two or more scenario models of the plurality of scenario models; and
producing the structural or outcome differences that characterize a divergence between the plurality of supply chain scenarios based on the identified one or more changes in the quantitative measures between the two or more scenario models.

16. The computer-implemented method of claim 15, further comprising generating a natural-language summary or recommendation based on the structural or outcome differences, the generating comprising invoking a first agent among the plurality of agents to translate the structural or outcome differences into an explanation of one or more implications.

17. One or more non-transitory computer-readable media storing one or more sequences of instructions which, when executed using a computer system, cause the computer system to execute:
receiving in a visual user interface a natural-language query specifying a supply chain problem;
identifying a plurality of analytical tasks contained in or implied by the natural-language query;
generating a meta optimization model representing the plurality of analytical tasks, wherein the meta optimization model comprises a plurality of agents corresponding to a plurality of analysis operations and a plurality of constraints characterizing dependencies between the plurality of analysis operations;
programmatically calling a constrained optimization solver to solve the meta optimization model and receiving from the constrained optimization solver a response specifying a sequence of analysis operations and an assignment of each analysis operation among the sequence of analysis operations to one or more agents of a plurality of agents;
for each analysis operation, invoking a particular agent specified in the assignment to execute the analysis operation and receiving a response specifying an execution result for each analysis operation;
generating a distilled result based on the execution result for each analysis operation;
generating a natural-language response based on the distilled result; and
presenting in the visual user interface the natural-language response as a response to the natural-language query.

18. The one or more non-transitory computer-readable media of claim 17, further comprising sequences of instructions which when executed by the computer system cause:
for each analysis operation, accessing one or more intermediate results from the one or more agents and evaluating an output complexity of the one or more intermediate results from the one or more agents using one or more complexity metrics.

19. A computer system, comprising:
one or more central processing units;
one or more network interfaces that are configured to communicatively couple the one or more central processing units to a data communication network; and
electronic digital random access memory storing a plurality of sequences of stored program instructions which, when executed using the computer system, cause the computer system to execute:
receiving in a visual user interface a natural-language query specifying a supply chain problem;
identifying a plurality of analytical tasks contained in or implied by the natural-language query;
generating a meta optimization model representing the plurality of analytical tasks, wherein the meta optimization model comprises a plurality of agents corresponding to a plurality of analysis operations and a plurality of constraints characterizing dependencies between the plurality of analysis operations;
programmatically calling a constrained optimization solver to solve the meta optimization model and receiving from the constrained optimization solver a response specifying a sequence of analysis operations and an assignment of each analysis operation among the sequence of analysis operations to one or more agents of a plurality of agents;
for each analysis operation, invoking a particular agent specified in the assignment to execute the analysis operation and receiving a response specifying an execution result for each analysis operation;
generating a distilled result based on the execution result for each analysis operation;
generating a natural-language response based on the distilled result; and
presenting in the visual user interface the natural-language response as a response to the natural-language query.

20. The computer system of claim 19, the plurality of sequences of stored program instructions which, when executed using the computer system, causing the computer system to further execute:
for each analysis operation, accessing one or more intermediate results from the one or more agents and evaluating an output complexity of the one or more intermediate results from the one or more agents using one or more complexity metrics.
